(19) United States
(12) Patent Application Publication
(10) Pub. No.: US 2002/0066580 A1
(43) Pub. Date: Jun. 6, 2002

(54) CABLES ARRESTER, IN COMBINATION WITH AN ENERGIZED FLUID CONDUIT

(76) Inventor: JOHN MELLARDO, TRUMBULL, CT (US)

Correspondence Address: MENOTTI J LOMBARDI, ITT FLUID TECHNOLOGY, 10 MOUNTAINVIEW ROAD, UPPER SADDLE RIVER, NJ, 07458

(21) Appl. No.: 09/295,212

(22) Filed: Apr. 21, 1999

(51) Int. Cl. H02G 15/24

(52) U.S. Cl. 174/22 R

(57) ABSTRACT

A platform, with end bracketing, is fastened across an intermediate portion of an energized-fluid conduit. The conduit conducts an energized fluid, namely: water, therethrough, and the platform securely spaces apart electrical power cabling which is confined in the conduit for coupling with an axial flow pump, in a lower portion of the conduit. By arrestingly spacing apart the cabling, the possibility of the cables, in the turbulent-flow environment in the conduit, slapping against each other, and abrading sheathing and/or insulation, is obviated. Hence, any likelihood of electrical shorting is prevented.

### BACKGROUND OF THE INVENTION

This invention pertains to submersible, axial flow pumps which are utilized for large volume, fluid handling in low lift applications. These pumps are used in many different environments, for example: water park rides at amusement parks. The pumps are mounted in large tubes or conduits through which the pumps convey the fluids up and out of the tubes or conduits. The pumps are self-contained, with the pump and motor therefor assembled as one unit. Accordingly, the electric power supply cables must be located in the pumped media to facilitate attachment to the motor-pump unit.

With the electric power supply cables arrayed in the flow path of the media, in the tube or conduit, they are susceptible to damage through the turbulence of the media. The latter can cause the cables to slap against each other, and abrade the cable coating and/or sheathing thereof, giving rise to the possibility of electrical shorting.

What has been needed is some practical means for supporting the cables, in such turbulent media, in an arrested, spaced-apart disposition, within the media-conveying tube or conduit.

It is an object of this invention, then, to set forth the needed means for arresting cables, securely spaced-apart from each other, within a media-pumped conduit.

### SUMMARY OF THE INVENTION

It is, particularly, an object of this invention to disclose a cables arrester, in combination with an energized-fluid conduit, comprising a conduit for the conduct of an energized fluid therethrough; a plurality of power cables confined within said conduit; and means removably fixed in said conduit for holding cables of said plurality thereof in spaced-apart disposition across said conduit. Further objects of this invention, as well as the novel features thereof, will become apparent by reference to the following description, taken in conjunction with the accompanying figures.

### BRIEF DESCRIPTION OF THE FIGURES

FIG. 1 is a vertical, partly cross-sectioned illustration of a conduit for conducting an energized fluid, namely: water, therethrough, a lower portion of the conduit, having an axial flow pump disposed therein, is phantomed, and an upper portion is cross-sectioned, and has a discharge pipe and a cables arrester, in accordance with an embodiment of the invention;

FIG. 2 is substantially a line illustration, greatly enlarged over the scale of FIG. 1, taken along section 2-2 of FIG. 3, albeit with cabling, sheathing, and strain-relief devices included; and

FIG. 3 is a perspective drawing of the support platform, platform brackets, and pipe couplers, for bridging across the conduit and receiving the cabling in spaced-apart disposition; here, the cabling, sheathing and strain-relief devices are omitted for clarity.

### DETAILED DESCRIPTION OF THE PREFERRED EMBODIMENT

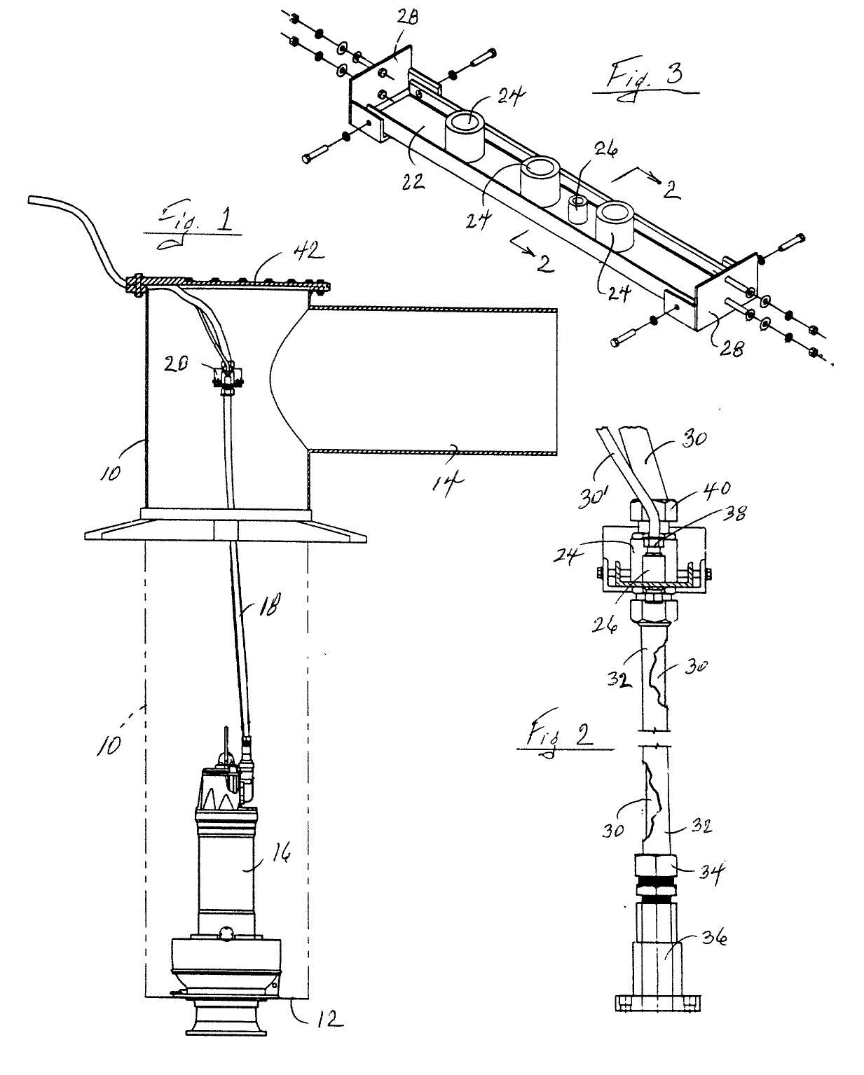

FIG. 1 depicts a vertically disposed conduit 10 which is provided for a conduct of an energized fluid, namely: water in this embodiment of the invention, therethrough from an entry 12 thereof, to a discharge outlet or discharge pipe 14 thereof. At the entry 12 of the conduit 10 is fastened (by means not shown) an axial flow pump 16 for impelling the water through the conduit 10 to the discharge pipe 14. The pump 16 is electrically powered and, accordingly, powering and control cables need to be disposed in the water environment, within the conduit 10, for attachment to the pump in order that the pump 16 can operate. In FIG. 1, sheathed cables 18 are depicted, the same reaching between the pump 16 and means 20. The latter means, according to the invention, comprises a cables arrester for holding cables and sheathed cables in a spaced-apart disposition across the conduit 10.

The means 20, the cables arrester, is shown in greater scale in FIGS. 2 and 3. Cable arrester means 20 comprises a channel-shaped platform 22 which is apertured to receive, in alignment with the apertures, internally-threaded pipe couplers 24 and 26. The platform 22 engages, at opposite ends thereof, wall brackets 28. As best seen in FIG. 3, the brackets 28 have fasteners which removably fix the brackets 28 to opposite wall surfaces of the conduit 10, in order to establish the cables arrester 20 bridgingly across the conduit 10 in adjacency to the discharge pipe 14. Additional hardware removably fastens ends of the platform 22 to the brackets 28.

The discontinuous portion of illustration in FIG. 2 comprises a cable 30 confined within a jacketing sheath 32. Portions of the sheath 32 are cut-away to show the inner cable 30. Ends of the sheath 32 terminate in externally-threaded pipe fittings 34. One of the fittings 34 threadedly engages an internally threaded, hollow stanchion 36 which is attachable to the pump 16 to lead cables, such as cable 30, into the pump 16.

The cables are sheathed to afford protection from any large objects which may be carried in the medium, the water, in the conduit 10.

Fittings 34 at the uppermost ends of each sheath 32 are threadedly engaged with the pipe couplers 24 and 26, and by this means, the sheathed cables 30 are held in spaced-apart disposition in the conduit 10. Secured by the pipe couplers and pipe fittings, the sheathed cables are capable of withstanding any tubulent fluid-flow conditions in the conduit 10.

Threadedly engaged with the pipe couplers 24 and 26, at the top of the cable arrester 20, are strain-relief devices 38 and 40. Devices 38 and 40 comprise grips which, when tightened about their respective cables, prevent the cables from slipping through the pipe couplers 24 and 26. Devices 38 and 40 are proprietary items marketed by Hubbell Inc., Bridgeport, Conn., and are sold under the trademark DELUXE CORD GRIP, out of the Kellems Division of Hubbell Inc., in Stonington, Conn. Exemplary ones bear a catalog number 074-01-1030. The DELUXE CORD GRIP contains a rubber grommet (not shown) which seals around the subject cable for a water-tight fit.

Above the cables arrester 20, the cables 30 and 30′ are led out of the conduit 10, as shown in FIG. 1, via a closure cap 42; the latter securely clamps the exiting cables, the latter proceeding on to a power source and control circuitry (not shown). The energized water passes out of the discharge pipe 14

The invention accommodates for secure support of electrical cables in a turbulent fluid environment. It presents a substantially self-contained assembly with the sheathed power cables and the conduit bridging support bundled together as one unit. As can be appreciated, the aforesaid bridging support allows for the electrical power cables to be installed and removed all together with the axial flow pump.

While I have described the invention in connection with a specific embodiment thereof, it is to be clearly understood that this is done only by way of example and not as a limitation to the scope of the invention, as set forth in the objects thereof, and in the appended claims.

I claim:

1. A cables arrester, in combination with an energized-fluid conduit, comprising:
a conduit for the conduct of an energized fluid therethrough;
a plurality of power cables confined within said conduit; and
means removably fixed in said conduit for holding cables of said plurality thereof in spaced-apart disposition across said conduit.

2. A cables arrester, according to claim 1, wherein:
said means comprises means bridging across an intermediate portion of said conduit.

3. A cables arrester, according to claim 2, wherein:
By said bridging means comprises a platform, and conduit-engaging supports for said platform.

4. A cables arrester, according to claim 2, wherein:
said bridging means comprises an apertured platform, threaded pipe couplers in fixed alignment with apertures in said platform, and brackets for removably fixing said platform across said conduit.

5. A cables arrester, according to claim 1, wherein:
said cables are jacketed with sheathing.

6. A cables arrester, according to claim 4, wherein:
said cables are jacketed with sheathing;
said sheathing terminates in threaded pipe fittings; and
said pipe fittings are threadedly engaged with said pipe couplers.

7. A cables arrester, according to claim 1, further including:
means engaged with said cables of said plurality thereof for strain-relieving said cables.

8. A cables arrester, according to claim 1, further including:
means for energizing fluid within said conduit; and wherein
said cables are coupled to said fluid energizing means.

9. A cables arrester, according to claim 5, further including:
an axial flow pump; and wherein
said sheathing terminates in threaded pipe fittings; and
said pump has a threaded pipe coupler in which threadedly to receive a sheathing pipe fitting.
